(19) United States
(12) Patent Application Publication
(10) Pub. No.: US 2022/0195949 A1
(43) Pub. Date: Jun. 23, 2022

(54) CHARGE FORMING DEVICE WITH A THROTTLE VALVE PROVIDING CONTROLLED AIR FLOW

(71) Applicant: Walbro LLC, Cass City, MI (US)

(72) Inventors: Gary J. Burns, Millington, MI (US); Jeffrey C. Hoppe, Cass City, MI (US); David L. Speirs, Cass City, MI (US)

(21) Appl. No.: 17/360,700

(22) Filed: Jun. 28, 2021

(51) Int. Cl. F02D 9/10

(52) U.S. Cl. CPC F02D 9/1065; F02D 9/1005

(57) ABSTRACT

In at least some implementations, a throttle valve includes a valve shaft having an axis and a mounting surface, and a valve head secured to the valve shaft. The valve head has a front face and a rear face closer to the mounting surface than the front face, the mounting surface being located so that a thickness of the valve head between the front face and the rear face is not coincident with the axis. And the axis is closer to the front face than to the rear face, or the axis is coincident with the rear face, or the axis is offset from the front face by more than the distance between the front face and rear face.

### TECHNICAL FIELD

The present disclosure relates generally to a throttle valve for a charge forming device.

### BACKGROUND

Many engines utilize a throttle valve to control or throttle air flow to the engine in accordance with a demand on the engine. Such throttle valves may be used, for example, in throttle bodies of fuel injected engine systems. Many such throttle valves include a valve head carried on a shaft that is rotated to change the orientation of the valve head relative to fluid flow in a passage, to vary the flow rate of the fluid in and through the passage. In some applications, the throttle valve is rotated between an idle position, associated with low speed and low load engine operation, and a wide open or fully open position, associated with high speed and/or high load engine operation. In the idle position, some air flow is permitted around the periphery of a throttle valve head, or through one or more holes in the throttle valve head, to support idle engine operation.

### SUMMARY

In at least some implementations, a throttle valve includes a valve shaft having an axis and a mounting surface, and a valve head secured to the valve shaft. The valve head has a front face and a rear face closer to the mounting surface than the front face, the mounting surface being located so that a thickness of the valve head between the front face and the rear face is not coincident with the axis. And the axis is closer to the front face than to the rear face, or the axis is coincident with the rear face, or the axis is offset from the front face by more than the distance between the front face and rear face.

In at least some implementations, the front face is closer to the axis than is the rear face. In at least some implementations, the rear face is closer to the axis than is the front face.

In at least some implementations, a charge forming device through which air flows to an engine includes a body having a throttle bore and a valve shaft bore, a valve shaft and a valve head. The throttle bore has an inlet through which air is received into the throttle bore, an outlet from which air exits the throttle bore, an axis between the inlet and the outlet, and the valve shaft bore extends through the throttle bore. The valve shaft is received in the valve shaft bore for rotation relative to the body, the valve shaft has an axis and a mounting surface located within the throttle bore. And the valve head is secured to the valve shaft, has a front face and a rear face closer to the mounting surface than the front face. The mounting surface is located so that a thickness of the valve head between the front face and the rear face is not coincident with the axis, and wherein the axis is closer to the front face than to the rear face, or the axis is coincident with the rear face, or the axis is offset from the front face by more than the distance between the front face and rear face.

In at least some implementations, the front face is closer to the axis than is the rear face. In at least some implementations, the rear face is closer to the axis than is the front face. In at least some implementations, the device includes a fluid feature through which fluid flows, and wherein the valve head is positioned relative to the axis to increase a gap between the valve head and the main body within the throttle bore to enable more air to flow past the valve head and to the fluid feature when the throttle valve is in the idle position. The fluid feature may be a boost venturi or a fuel port, in at least some implementations.

In at least some implementations, a method of fitting a throttle valve to a charge forming device includes the steps of:

determining a first flow area of a first gap in an idle position of the throttle valve within a throttle bore of the charge forming device;

determining a second flow area of a second gap in the idle position of the throttle valve; and

selecting a combination of: 1) a throttle valve head; 2) a throttle valve shaft having a mounting surface in a particular location; and 3) a valve bore offset relative to an axis of the throttle bore, to achieve the determined first flow area and the determined second flow area, where the second flow area is different than the first flow area.

In at least some implementations, at least one of the first flow area and second flow area is sized to provide an air flow to a fluid feature downstream from the throttle valve shaft, wherein the air flow is increased compared to the air flow that would occur if the area of the first flow area and the second flow area were equal.

### BRIEF DESCRIPTION OF THE DRAWINGS

The following detailed description of certain embodiments and best mode will be set forth with reference to the accompanying drawings, in which:

FIG. 1 is a perspective view of a throttle body assembly with a throttle valve in a throttle bore;

FIG. 2 is a diagrammatic view of the throttle bore and a valve head of the throttle valve;

FIG. 3 is a cross-sectional view taken generally along line 3-3 of FIG. 2;

FIG. 4 is a cross-sectional view similar to FIG. 3 and showing another throttle valve;

FIG. 5 is a cross-sectional view similar to FIG. 3 and showing another throttle valve;

FIG. 6 is a cross-sectional view similar to FIG. 3 and showing another throttle valve;

FIG. 7 is a cross-sectional view similar to FIG. 3 and showing another throttle valve;

FIG. 8 is a bar chart showing flow areas of three different throttle valves including valve heads at different positions relative to a valve shaft axis;

FIG. 9 is a bar chart showing flow areas of three different throttle valves including valve heads of different thicknesses;

FIG. 10 is a perspective view of the throttle body assembly from a rear of the assembly, and showing a boost venturi; and

FIG. 11 is fragmentary sectional view of the throttle body assembly.

### DETAILED DESCRIPTION

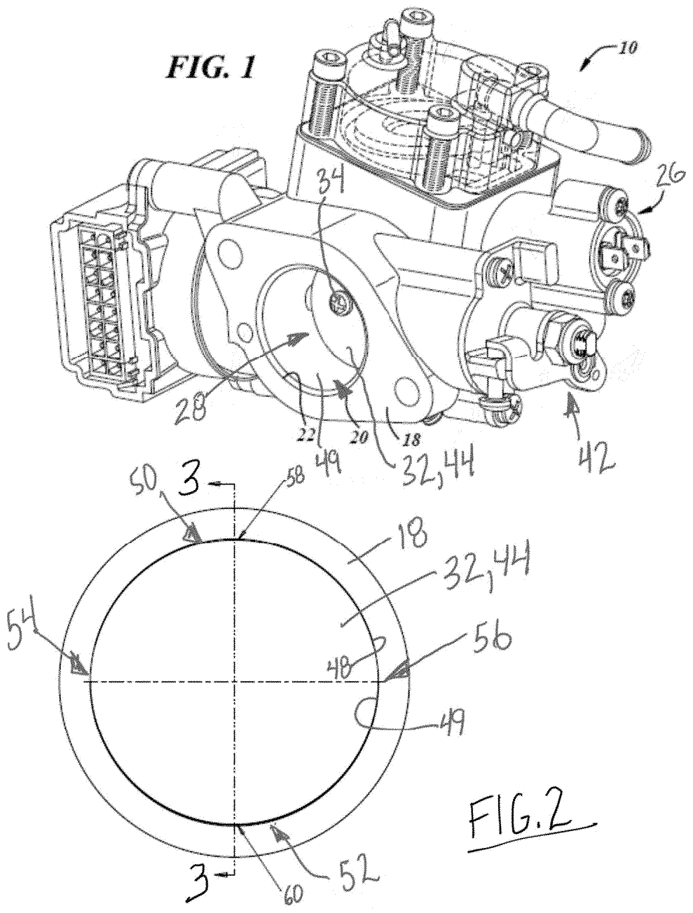

Referring in more detail to the drawings, FIGS. 1, 10 and 11 illustrate a charge forming device 10 that provides a combustible fuel and air mixture to an internal combustion engine 12 (labelled in FIG. 11) to support operation of the engine. The charge forming device 10 may be utilized on a two or four-stroke internal combustion engine, and in at least some implementations, includes a throttle body assembly 10 from which air and fuel are discharged for delivery to the engine 12.

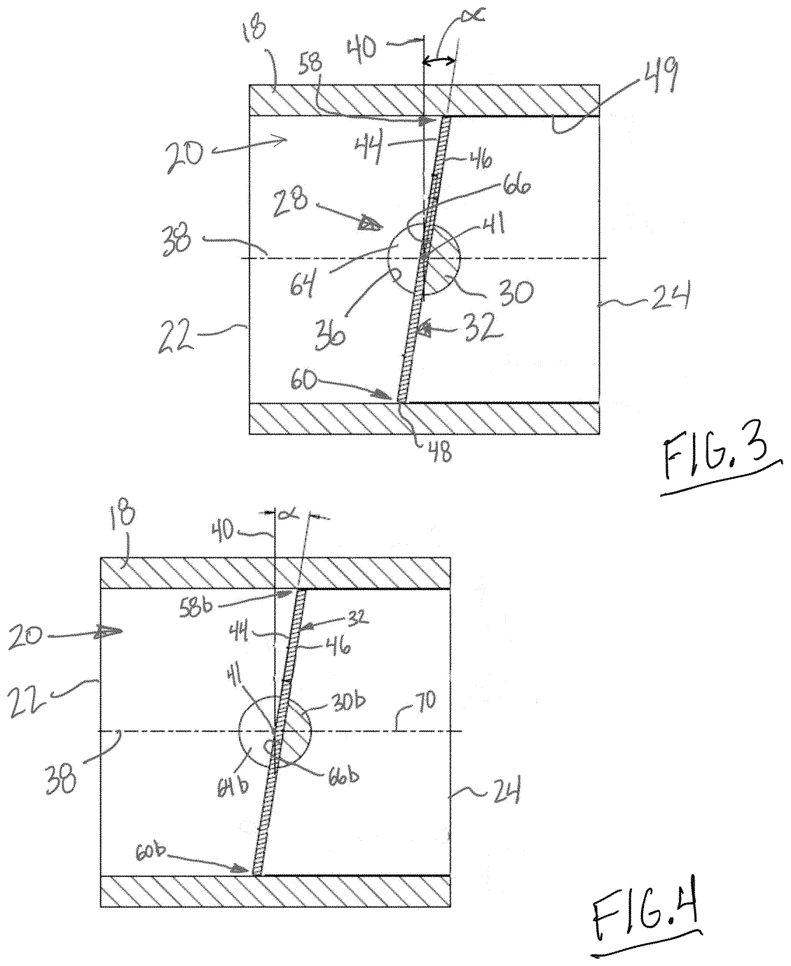

The assembly 10 includes a main body 18 that has a throttle bore 20 with an inlet 22 through which air is received into the throttle bore 20 and an outlet 24 (labeled in FIGS. 3, 10 and 11) connected or otherwise communicated with the engine (e.g., an intake manifold 25 (FIG. 11) thereof). The inlet 22 may receive air from an air filter, if desired, and that air may be mixed with fuel provided from a fuel metering valve 26 carried by or communicated with the main body 18. The fuel and air mixture is delivered to a combustion chamber or piston cylinder of the engine during sequentially timed periods of a piston cycle. For a four-stroke engine application, as illustrated, the mixture may flow through an intake valve and directly into the piston cylinder. Alternatively, for a two-stroke engine application, typically air flows through the crankcase before entering the combustion chamber portion of the piston cylinder through a port in the cylinder wall which is opened intermittently by the reciprocating engine piston.

The throttle bore 20 may have any desired shape including (but not limited to) a constant diameter cylinder, or a venturi shape wherein the inlet leads to a tapered converging portion that leads to a reduced diameter throat that in turn leads to a tapered diverging portion that leads to the outlet 24. The converging portion may increase the velocity of air flowing into the throat and create or increase a pressure drop in the area of the throat.

Referring to FIG. 1, the air flow rate through the throttle bore 20 and into the engine is controlled at least in part by a throttle valve 28. As shown in FIG. 3, the throttle valve 28 includes a throttle valve shaft 30 and a throttle valve head 32 mounted, such as by one or more screws 34 (FIG. 1), to the valve shaft 30. The valve shaft 30 is rotatably carried by or relative to the main body 18 such as in a valve shaft bore 36 that is formed in the main body 18 and extends transversely across the throttle bore 20 to enable rotation of the throttle valve head 32 relative to the throttle bore 20. In at least some implementations, the throttle valve head 32 is defined by a flat disc commonly referred to as a butterfly valve head 32. The throttle valve 28 is rotated between an idle position and a wide open position, and may be operated at various positions in between those two positions. In the idle position, the throttle valve head 32 is substantially transverse to an axis 38 of the throttle bore 20, and may be positioned at an angle a (FIG. 3) of between about three (3) and twenty (20) degrees from a plane 40 that extends through an axis 41 of the valve shaft 30 and is transverse to the throttle bore axis 38. In this position, the throttle valve head 32 provides a maximum restriction to air flow out of the throttle bore 20, but allows sufficient air or fluid flow to support idle engine operation. In the wide open position of the throttle valve 28, the throttle valve head 32 typically is generally parallel to the throttle bore axis 38 of the throttle bore 20 (where generally parallel is within 10 degrees of parallel), and provides a minimum restriction to air flow out of the throttle bore 20 and to the engine.

The throttle valve 28 may be driven or moved by an actuator 42 (FIG. 1) between the idle and wide open positions. In one example, the actuator 42 may be an electrically driven motor coupled to the throttle valve shaft 30 to rotate the valve shaft 30 and thus rotate the valve head 32 within the throttle bore 20. In another example, the actuator 42 may include a mechanical linkage, such as a lever attached to the throttle valve shaft 30 to which a Bowden wire may be connected to manually rotate the valve shaft 30 as desired and as is known in the art.

The throttle body 10 also has one or more fuel circuits through which fuel is provided into the throttle bore 20 and combined with air flowing through the throttle bore 20 to form the fuel and air mixture. The fuel circuit(s) may include a fuel injector or other fuel metering device 26, through which fuel is discharged into the throttle bore 20. In at least some implementations, the fuel may be discharged at a pressure of 1 bar or less, including some systems having a fuel pressure of 0.35 bar or less. Of course, the throttle body or a different fuel and air charge forming device having a throttle valve as set forth herein, may be used in other applications.

As shown in FIG. 3, the valve head 32 has a front face 44 that, when the throttle valve 28 is in the idle position, is closer to the throttle bore inlet 22 than is a rear face 46 on the opposite side of the valve head 32. The front and rear faces 44, 46 may be generally planar and parallel to each other. To provide a desired fit of the valve head 32 within the throttle bore 20, the valve head 32 may have a diameter that is chosen as a function of the diameter of the throttle bore 20, taking into account the usual scenario in which the valve head 32 in the idle position is rotated, such as between three (3) and twenty (20) degrees, relative to the plane 40 that is perpendicular to the throttle bore axis 38 of the throttle bore 20, as shown in FIG. 3. In at least some implementations, the valve head 32 may be stamped from sheet metal, although the valve head 32 could be formed from a material other than metal, such as a composite, polymer, or a combination of materials, as desired. In at least some implementations, the periphery 48 of the valve head 32 may be arranged at a non-perpendicular angle to the front and rear faces 44, 46, to provide a desired relationship with the surface 49 defining the throttle bore 20. In at least some implementations, the angle may be between about three (3) and fifteen (15) degrees from perpendicular to the front face 44 of the throttle valve head 32. This angle may be provided by stamping the valve head 32 from a flat metal sheet at the desired angle, and the result is a valve head 32 having a periphery which is not circular, and wherein the rear face 46 and front face 44 are offset by an amount that is a function of the thickness of the valve head 32 and the noted angle. In at least some implementations, the offset may be provided at first and second portions 50, 52 of the valve head 32, and not at opposite side portions 54, 56, where the side portions 54, 56 overlap the throttle valve shaft 30 and the first and second portions 50, 52 do not overlap the throttle valve shaft 30. Thus, relative to the front face 44, part of the periphery of the valve head 32 at either the first portion 50 or second portion 52 will extend beyond and will not be overlapped by the front face 44, and the periphery at the other of the first or second portion of the valve head 32 will be overlapped by the front face 44 (e.g. may appear as an undercut relative to the front face 44).

In at least some implementations, in the idle position, as shown in FIGS. 2 and 3, there is a first gap 58 defined between the throttle bore surface 49 and the first portion 50 of the throttle valve head 32, and a second gap 60 defined between the throttle bore surface 49 and the second portion 52 of the throttle valve head 32. The second portion 52 may be diametrically opposite to the first portion 50, and the first and second portions 50, 52 are spaced from the valve shaft 30 which defines the axis 41 about which the throttle valve 28 rotates. Mid-portions of the first and the second portions 50, 52, respectively, may be spaced ninety (90) degrees from the valve shaft axis 41, and the first gap 58 and second gap 60 may be largest at the mid-point, at least with a throttle bore 20 that is circular in the area of the valve head 32, and with a generally circular valve head 32. The first and second gaps 58, 60 increase in size as the throttle valve 28 is rotated away from the idle position.

As shown in FIG. 3, the valve shaft 30 may include a recess 64 providing a flat mounting surface 66 against which a rear face 46 of the throttle valve head 32 is received. The mounting surface could also be defined by a slot or other void in the valve shaft 30, with the valve head 32 received in the slot or void. In at least some implementations, one or more openings in the mounting surface 66 and through the valve head 32 receive the screw(s) 34 (FIG. 1) to fix the valve head 32 to the valve shaft 30. In the implementation shown in FIG. 3, the recess 64 has a depth that is greater than one-half the diameter of the valve shaft 30 by an amount equal to one-half the thickness of the valve head 32, where the thickness is the distance between the front face 44 and the rear face 46 of the throttle valve head 32. Thus, the mounting surface 66 is offset from the valve shaft axis 41, and the valve shaft axis 41 passes through the center of the valve head 32. In such an arrangement, the first gap 58 and second gap 60 are equal.

In FIG. 4, the valve head 32 is mounted to a valve shaft 30b having a recess 64b has a depth that is greater than one-half the diameter of the valve shaft 30b by more than one-half the thickness of the valve head 32. In the description of the throttle valve shown in FIG. 4, The letter ‘b’ will be used with various reference numerals to designate components modified in FIG. 4 compared to those described with reference to FIG. 3. Thus, the mounting surface 66b (e.g. the center thereof) is offset from the valve shaft axis 41. If the valve shaft 30b were rotated until the mounting surface 66b was parallel to the plane 40 including the valve shaft axis 41 and perpendicular to throttle bore 20, the entire mounting surface 66b would be offset and downstream from the plane 40. Such a position of the valve shaft 30b does not occur in at least this implementation of the device, so the reference to the mounting surface 66b being offset relates to a middle or center of the mounting surface 66b which is the portion intersected by a plane 70 including the throttle bore 20 axis and perpendicular to the valve shaft axis 41. In such an arrangement, the valve shaft axis 41 does not pass through the center of the valve head 32 (in the thickness dimension), and the first gap 58b is greater than the second gap 60b. In the example shown, the mounting surface 66b is offset from the valve shaft axis 41 by the full thickness of the valve head 32 such that the valve shaft axis 41 is coincident with the front face 44 of the throttle valve head 32. In other implementations, the recess 64b may have a depth that is greater than one-half the valve shaft diameter by more than half the thickness of the valve head 32, including by more than the full thickness of the valve head 32, such that the valve shaft axis 41 is closer to the front face 44 than the rear face 46.

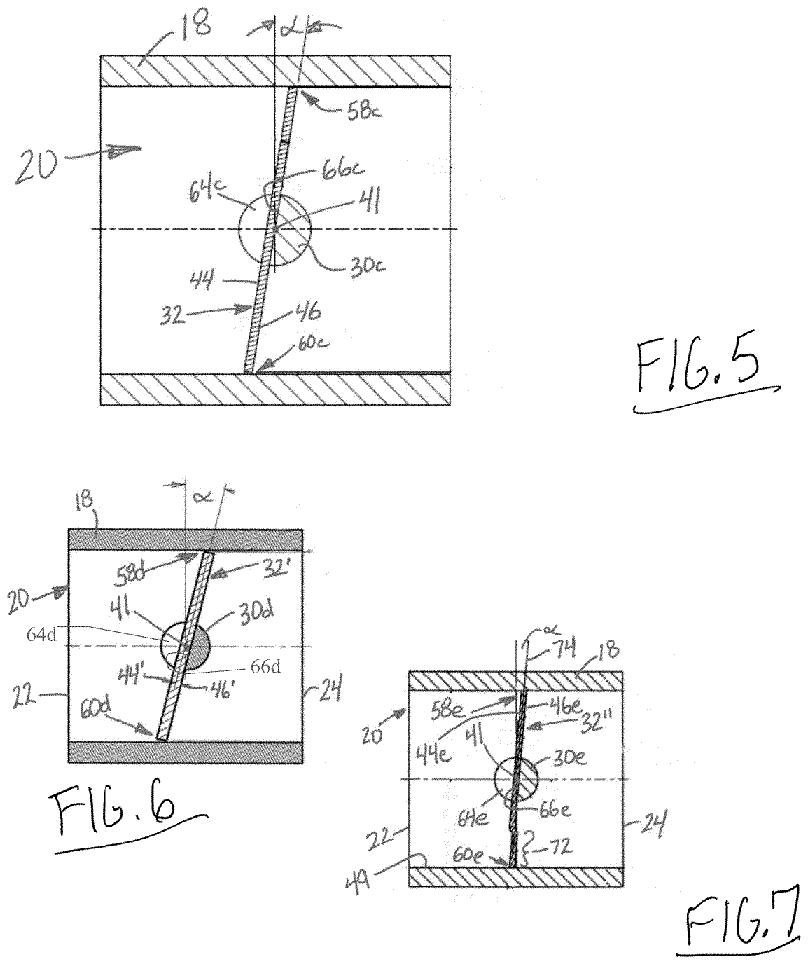

FIG. 5 shows another throttle valve arrangement in which the valve head 32 is mounted to a valve shaft 30c having a recess 64c with a depth that is equal to one-half the diameter of the valve shaft 30c. In the description of the throttle valve shown in FIG. 5, The letter ‘c’ will be used with various reference numerals to designate components modified in FIG. 5 compared to those described with reference to FIG. 3. The mounting surface 66c lies along the valve shaft axis 41, and the valve shaft axis 41 does not pass through the center of the valve head 32 (in the thickness dimension), but is coincident with or lies along the rear face 46 of the valve head 32. In such an arrangement, the first gap 58c and second gap 60c are not equal, and the first gap 58c is less than the second gap 60c. In the example show, the center of the mounting surface 66c is coincident with the valve shaft axis 41, but in other implementations the recess 64c may have a depth that is greater than one-half the valve shaft diameter by less than half the thickness of the valve head 32, or the recess 64c could have a depth less than one-half the diameter of the valve shaft 30c such that the valve shaft axis 41 is closer to the rear face 46 than the front face 44.

By changing the position of the mounting surface 66, 66b, 66c relative to the valve shaft axis 41, the position of the front face 44 of the valve head 32 is changed, and the sizes of the first and second gaps 58, 58b, 58c, 60, 60b, 60c can be changed to provide a desired fluid flow around the valve head 32 in at least the idle position of the valve head 32, and within some angular range of movement of the valve head 32 away from the idle position. This can help, for example, to control fuel flow into and through the throttle bore 20, but providing a desired rate of air flow in areas or portions of the throttle bore 20 into which fuel is provided. Again by way of example, if fuel enters the throttle bore 20 near a lower portion of the throttle bore 20 (e.g. lower with reference to gravity), then the second gap 60, 60b, 60c can be controlled as desired to increase or decrease air flow when the valve head 32 is in the idle position and as the valve head 32 moves off idle.

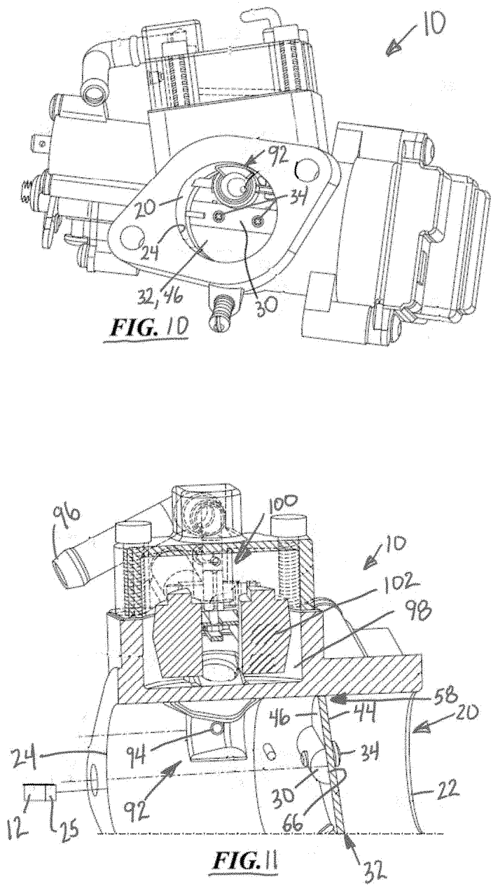

Further by way of example, if a boost venturi 92 is provided within the throttle bore 20, such as nearer a portion of surface defining the throttle bore 20 aligned with the first gap 58, 58b, 58c as shown in FIGS. 10 and 11 (i.e. not coaxial with the throttle bore) then the first gap 58, 58b, 58c can be controlled to provide a desired air flow to the boost venturi 92. In this example, the boost venturi 92 is a venturi located within the throttle bore 20 and having a smaller cross-sectional flow area than the throttle bore 20. A fuel port 94 is provided in the boost venturi 92 so that fuel enters the boost venturi 92 at least partially as a function of the fluid flow rate through the boost venturi 92. This is an example of a low pressure fuel delivery system in which fuel is not forcibly discharged under higher pressure into the throttle body or intake manifold. Instead, fuel may flow under the force of gravity and/or in response to a reduced pressure caused by fluid flow through the throttle bore and boost venturi. In the example shown and with specific reference to FIG. 11, fuel from a fuel source (e.g. fuel tank) is provided through an inlet 96 to a fuel chamber 98 when a valve 100 (shown as being actuated by a float 102) is open. The fuel chamber 98 may be at or near atmospheric pressure, and fuel from the fuel chamber may be routed to the fuel metering valve 26 for delivery into the throttle bore 20 via the fuel port 94 and/or other fuel ports. Thus, directing air to the boost venturi 92 when the throttle valve is in its idle position or near the idle position can improve the fuel flow into the boost venturi and the fuel delivered to the engine. An example of a boost venturi and low pressure fuel delivery system is shown in U.S. Patent Application Publication No. 2019/0120193, the disclosure of which is incorporated herein by reference in its entirety.

Further, controlling the gaps 58, 58b, 58c, 60, 60b, 60c can help remove via an air flow puddles of fuel from the throttle bore 20 or engine intake 25, can eliminate or reduce the need for holes or slots in the throttle valve head 32 to provide a desired air flow through or around the valve head 32, and can improve the ability to control and air/fuel ratio of the fuel mixture delivered to the engine when the throttle valve 28 is at or near (i.e. moving off or moving toward) the idle position. Such changes and control over the air flow in the throttle bore 20 can provide improved engine performance and exhaust emissions can be decreased. Further, while described above with reference to a throttle body 10, the innovations can be used in a diaphragm carburetor, float bowl carburetor, split bore or stratified scavenging fuel systems and in high or low pressure fuel injection systems.

Another way to change the position of the front face 44 of the valve head 32 relative to the valve shaft axis 41 is to change the thickness of the valve head 32. For a given position of the mounting surface 66, when the throttle valve 28 is in the idle position, a thicker valve head will have its front face 44 closer to the throttle bore inlet 20 than will a thinner valve head. This provides a similar affect as changing the position of the mounting surface 66 relative to the valve shaft axis 41. So the first gap 58 and second gap 60 can be controlled both as a function of valve head thickness and mounting surface 66 location.

In FIG. 6, another throttle valve 28 is shown. This throttle valve includes a valve shaft 30d and a thicker valve head 32′ (dimension between front face 44′ and rear face 46′). The recess 64d positions the mounting surface 66d so that the valve shaft axis 41 extends through the center of the valve head 32′. This provides, in the construction of FIG. 6, a first gap 58d that is the same as the second gap 60d, whereas the thinner valve head 32 in FIG. 4, which also centered the valve head 32 on the axis 41 provides a larger first gap 58b than second gap 60b.

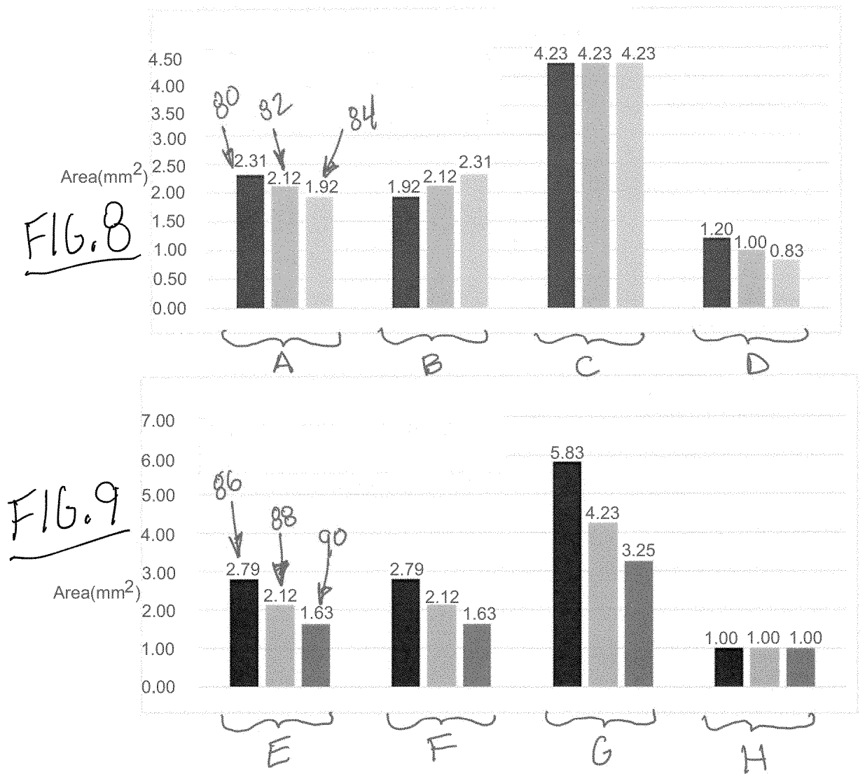

In FIG. 7, a throttle valve has a valve head 32″ mounted to a valve shaft 30e that may be similar to the valve shaft 30b in FIG. 4, with a recess 64e and mounting surface 66e arranged to provide the valve head 32″ centered on the valve shaft axis 41. The valve head 32″ has an offset portion 72 that is spaced from the valve shaft 30 and which defines the second gap 60e. The offset portion 72 provides front and rear faces 44e, 46e that are not planar. In this example, the front face 44e in the offset portion 72 is downstream of the remainder of the front face 44e, when the throttle valve 28 is in the idle position. That is, the offset portion 72 is shifted relative to a plane perpendicular to the throttle bore 20 and extending through the valve shaft axis 41 such that the front face 44e in the offset portion 72 is closer to a centerline 74 of the valve head 32″ outside of the offset portion 72 (where the centerline 74 is relative to the thickness dimension of that portion of the valve head 32″). In this way, the periphery of the valve head 32″ in the offset portion 72 is adjacent to a different portion of the throttle bore surface 49 when the throttle valve 28 is in the idle position than it would be if the front face 44e was planar. This provides a further way to control the gaps between the throttle valve head and the throttle bore surface 49. While shown as being in the area of the second gap 60e, an offset portion 72 could also or instead be in the area of the first gap 58e, that is, on the opposite side of the throttle valve shaft 30e.

Further, the valve shaft of a throttle valve could be offset relative to the throttle bore 20. That is, the throttle bore axis 38 could be offset from the valve shaft axis 41. This would mean that the valve head of a throttle valve having an offset valve shaft is not centered on the valve shaft, and thus, first and second gaps could be changed via a valve shaft offset.

The multi-section bar chart in FIG. 8 illustrates a flow area (in mm²) for the first gap 58 (in section A), second gap 60 (in Section B), combined flow areas of both the first and second gaps 58, 60 (in section C), and a ratio of first gap flow area:second gap flow area in (Section D). Each of sections A-D includes three bars, and each of the three bars represents a different valve head 80, 82, 84. The leftmost bar in each section relates to a first valve head 80, the center bar represents a second valve head 82 and the rightmost bar in each section represents a third valve head 84. All three valve heads 80, 82, 84 have a five (5) degree angle relative to a plane perpendicular to the throttle bore 20, a diameter of 28 mm and a thickness of 1.5 mm, the flow areas were taken with regard to the same throttle bore 20 and the valve shaft 30 was centered in the throttle bore 20 (i.e. no valve shaft 30 offset). The first valve head 80 is arranged like that shown in FIG. 4 and the first gap 58 has a greater flow area than the second gap 60, as shown by comparison of section A with section B, and the areas have a ratio of 1.2:1 as shown in section D. The second valve head 82 is arranged like that shown in FIG. 3 and the first gap 58 has the same flow area as the second gap 60 (i.e. a ratio of 1:1). The third valve head 84 is arranged like that shown in FIG. 5 and the first gap 58 has a lesser flow area than the second gap 60, as shown by comparison of section A with section B, and the areas have a ratio of 0.83:1 as shown in section D. As shown in section C, each valve head 80, 82, 84 provides the same total flow area so with valves having the parameters as noted it is only the relative sizes of the first and second gaps 58, 60 that is changed.

The multi-section bar chart in FIG. 9 illustrates a flow area (in mm²) for the first gap 58 (in section E), second gap 60 (in Section F), combined flow areas of both the first and second gaps 58, 60 (in section G), and a ratio of first gap flow area:second gap flow area in (Section H). Each of sections E-H includes three bars, and each of the three bars represents a different valve head 86, 88, 90. The leftmost bar in each section relates to a first valve head 86, the center bar represents a second valve head 88 and the rightmost bar in each section represents a third valve head 90. All three valve heads 86, 88, 90 were set at a five (5) degree angle relative to a plane perpendicular to the throttle bore 20, all have a diameter of 28 mm, the flow areas were taken with regard to the same throttle bore 20 and the valve shaft 30 was centered in the throttle bore 20 (i.e. no valve shaft 30 offset). In this example, each valve head 86, 88, 90 has a different thickness, with the first, second and third valve heads having thicknesses of, respectively, 0.81 mm, 1.50 mm and 2.00 mm. In this example, the mounting surface 66 of the valve shafts for each valve head are located such that the center of each valve, in the thickness dimension, is aligned with the valve shaft axis 41. Thus, as can be seen by comparison of sections E, F and H, the first and second gaps 58, 60 have the same flow area, and a first gap flow area: second gap flow area ratio of 1.0.

However, the size of the gaps 58, 60 varies as a function of the thickness of the valve head, with a thinner valve head having a larger gap than a thicker valve head. In this example, the first valve head 86 has a total flow area of about 5.83 mm and the third valve head 90 has a total flow area of 3.25 mm.

Of course, as noted herein, the valve head thickness, the position of the front face 44 relative to the valve shaft axis 41, the shape of the valve head 32 (e.g. present of one or more offset sections), and the valve shaft offset can be used in any desired combination. Changing these variables can be done to provide flow areas in the first gap 58 and second gap 60 that are of a desired total size and of a desired relative size between the two gaps, with the same valve shaft 30 and throttle bore 20.

Thus, a method of fitting a throttle valve to a charge forming device may include steps of: determining a first flow area of a first gap in an idle position of the throttle valve within a throttle bore of the charge forming device; determining a second flow area of a second gap in the idle position of the throttle valve; and selecting a combination of: 1) a throttle valve head; 2) a throttle valve shaft having a mounting surface in a particular location; and 3) a valve bore offset relative to an axis of the throttle bore, to achieve the determined first flow area and the determined second flow area, where the second flow area is different than the first flow area. In at least some implementations, at least one of the first flow area and second flow area is sized to provide an air flow to a fluid feature downstream from the throttle valve shaft, wherein the air flow is increased compared to the air flow that would occur if the area of the first flow area and the second flow area were equal.

By adjusting the relative size of the first and second gaps, air flow can be routed within the throttle bore in a desired manner when the throttle valve is in its idle position and in positions near idle, for example, within the first third of the angular rotation of the throttle valve between its idle and wide open positions. The air flow may be controlled with respect to a fluid feature through which a fluid flows (e.g. air or fuel or both), to provide more or less air to the fluid feature when the throttle valve is in its idle position or near idle, as noted above. Example fluid features are described above and include, but are not limited to, a boost venturi, intake manifold, fuel port, fuel injector, and fuel nozzle. Further, air may be directed in a manner that facilitates air scavenging of an engine combustion cylinder, or in a manner that works well with a fuel system providing a stratified scavenging arrangement in which fluid flow is split into more than one flow path. The gaps can be provided so that air flow at idle and in positions when the throttle valve is rotating away from idle can be reduced or delayed to facilitating engine scavenging, or to prevent unduly enleaning the fuel mixture provided to the engine in such throttle valve positions. In at least some implementation, the axis is closer to the front face than to the rear face, or the axis is coincident with the rear face, or the axis is offset from the front face by more than the distance between the front face and rear face.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A throttle valve, comprising:
a valve shaft having an axis and a mounting surface; and
a valve head secured to the valve shaft, the valve head having a front face and a rear face closer to the mounting surface than the front face, the mounting surface being located so that a thickness of the valve head between the front face and the rear face is not coincident with the axis, and wherein the axis is closer to the front face than to the rear face, or the axis is coincident with the rear face, or the axis is offset from the front face by more than the distance between the front face and rear face.

2. The throttle valve of claim 1, wherein the front face is closer to the axis than is the rear face.

3. The throttle valve of claim 1, wherein the rear face is closer to the axis than is the front face.

4. A charge forming device through which air flows to an engine, comprising:
a body having a throttle bore and a valve shaft bore, the throttle bore having an inlet through which air is received into the throttle bore, an outlet from which air exits the throttle bore, an axis between the inlet and the outlet, and the valve shaft bore extends through the throttle bore;
a valve shaft received in the valve shaft bore for rotation relative to the body, the valve shaft having an axis and a mounting surface located within the throttle bore; and
a valve head secured to the valve shaft, the valve head having a front face and a rear face closer to the mounting surface than the front face, the mounting surface being located so that a thickness of the valve head between the front face and the rear face is not coincident with the axis, and wherein the axis is closer to the front face than to the rear face, or the axis is coincident with the rear face, or the axis is offset from the front face by more than the distance between the front face and rear face.

5. The charge forming device of claim 4, wherein the front face is closer to the axis than is the rear face.

6. The charge forming device of claim 4, wherein the rear face is closer to the axis than is the front face.

7. The charge forming device of claim 4, which also includes a fluid feature through which fluid flows, and wherein the valve head is positioned relative to the axis to increase a gap between the valve head and the main body within the throttle bore to enable more air to flow past the valve head and to the fluid feature when the throttle valve is in the idle position.

8. The charge forming device of claim 7 wherein the fluid feature is a boost venturi or a fuel port.

9. A method of fitting a throttle valve to a charge forming device, comprising:
determining a first flow area of a first gap in an idle position of the throttle valve within a throttle bore of the charge forming device;
determining a second flow area of a second gap in the idle position of the throttle valve; and
selecting a combination of: 1) a throttle valve head; 2) a throttle valve shaft having a mounting surface in a particular location; and 3) a valve bore offset relative to an axis of the throttle bore, to achieve the determined first flow area and the determined second flow area, where the second flow area is different than the first flow area.

10. The method of claim 9 wherein at least one of the first flow area and second flow area is sized to provide an air flow to a fluid feature downstream from the throttle valve shaft, wherein the air flow is increased compared to the air flow that would occur if the area of the first flow area and the second flow area were equal.
